(19) United States
(12) Patent Application Publication
(10) Pub. No.: US 2026/0244664 A1
(43) Pub. Date: Aug. 20, 2026

(54) SYSTEM AND METHOD FOR LOW POWER GENERATION OF VISUALS FROM DOCUMENT TEXT

(71) Applicant: JPMorgan Chase Bank, N.A., New York, NY (US)

(72) Inventors: Murali VENKATASAMY, Princeton, NJ (US); Nidhi DAGA, Danville, CA (US)

(73) Assignee: JPMorgan Chase Bank, N.A., New York, NY (US)

(21) Appl. No.: 19/058,987

(22) Filed: Feb. 20, 2025

(51) Int. Cl. G06F 16/3332; G06T 11/00

(52) U.S. Cl. CPC G06F 16/3334; G06T 11/00

(57) ABSTRACT

A system and method for generating a visual content from a document that includes text is provided. The methodology includes: analyzing the document for metrics on appearance of the text within the document; identifying a frequency of occurrence of content within the document; calculating at least one readability score of the text within the document; first generating a large language model (LLM) prompt structured to instruct an LLM to create an image, the generating being per first predefined rules and based on results of the analyzing, the identifying, and the calculating; submitting the LLM prompt to a text-to-image model; receiving a visual from the text-to-image model in response to at least the submitting; second generating at least one score, per second predefined rules, for the visual; and returning to the first generating with recommendations to modify the LLM prompt.

### TECHNICAL FIELD

This disclosure relates to methods and apparatuses for using an artificial intelligence/machine learning (AI/ML) model to generate artwork from documents that include text.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

There is an overall interest in converting documents that include text (e.g., text alone, as well as text accompanied by artwork, tables, symbols, etc.) into visually engaging marketing content such as still images and moving images like posters or videos (collectively, “visuals” and singularly “visual”, although “a visual” is to be understood as one or more visuals). Traditionally, the documents would be given to an appropriate content creator, such as a graphic artist or video creator (collectively “content creator”), who then generates alone or with a team corresponding visuals from the document.

The traditional approaches to creating visuals have multiple technical and uniformity problems. A first technical problem is that creation of visuals is entirely subjective. Give two different content creators the same content, they will generate vastly different result visuals. There is no basis to establish uniform and consistent results between different content creators. This applies not only to the visual itself, but text (written or spoken words) content within the visual. For example, one content creator may have a blue preference, and another content creator has a red preference. In another example, if the target audience for the visual is college educated individuals, then the content creators' perception of that education level is again entirely subjective; one content creator may lean toward visuals more appropriate for college freshman while another content creator may generate visuals that lean toward college seniors.

It is known to use AI text-to-image models to generate images from a text LLM prompt. However, as the LLM prompts themselves are often subjective, the visuals from the model can vary considerably. Often the user is not satisfied with the response, such as the visual being too generic or not what the user was specifically looking for. The initial problem was the user, who typically is not trained in AI prompt formats, is not entering sufficiently targeted prompts to generate a satisfactory response. The user will then typically generate a modified prompt based on the prior response, and then receive a new response. If this new response is not satisfactory, the process can continue indefinitely. A technical problem with this methodology is that each AI prompt submission consumes a great deal of electrical power, such that continual resubmission of modified prompts in search of a satisfactory response consumes that much more power. Simply stated, receiving a satisfactory answer after ten AI prompt submissions consumes far more power than receiving a satisfactory response after one AI prompt submission.

Excessive power consumption is a particular technical problem in the field of AI art generation, in which a user enters a text prompt to describe an image, and the AI generates an image from the description. Since art appreciation is itself subjective, users are rarely satisfied with the initial resulting art, and thus will continually submit modified input prompts to alter the image more to their liking. This continual resubmission of input prompts to arrive at an acceptable end art product consumes a great deal of power.

### SUMMARY

The present disclosure, through one or more of its various aspects, embodiments, and/or specific features or sub-components, provides, among other features, various systems, servers, devices, methods, media, programs, and platforms for using an AI/ML model to convert documents that include text into visuals in an objective and uniform manner.

According to an embodiment, a method for generating a visual content from a document that includes text is provided. The method includes: analyzing the document for metrics on appearance of the text within the document; identifying a frequency of occurrence of content within the document; calculating at least one readability score of the text within the document; first generating a large language model (LLM) prompt structured to instruct an LLM to create an image, the generating being per first predefined rules and based on results of the analyzing, the identifying, and the calculating; submitting the LLM prompt to a text-to-image model; receiving a visual from the text-to-image model in response to at least the submitting; second generating at least one score, per second predefined rules, for the visual; and returning to the first generating with recommendations to modify the LLM prompt.

The method may have optional features. The visual may be a still image or a video image. The method may include accepting the visual in response to at least the at least one score satisfying the predetermined scoring criteria. The first predefined rules may define the LLM prompt to include a target audience identification, at least one keyword, a minimum readability score according to predetermined readability criteria, and physical layout directions for content of the image. The at least one score may include: a coherence score that represents a logic flow of content in the visual; a relevance score that represents alignment of the content of the visual with at least one target theme; and a number of keywords identified by the LLM prompt that are absent from the visual. The returning to the first generating with recommendations to modify the LLM prompt may include: third generating first instructions to add any missing keywords; fourth generating second instructions to increase the coherence score; and/or fifth generating third instructions to increase the relevance score. The analyzing the document for metrics may include determining word density of the document, character to word ratio, text to white space ratio, font weight average, font size distribution, and a percentage of the document covered by text. The at least one readability score may include a Flesch Reading Ease score, a Gunning Fog Index, and an average word length of words in the text.

According to an embodiment, a system for generating a visual content from a document that includes text is provided. The system includes a processor and a memory storing instructions programmed to cooperate with the processor to cause the system to perform operations. The operations include: analyzing the document for metrics on appearance of the text within the document; identifying a frequency of occurrence of content within the document; calculating at least one readability score of the text within the document; first generating a large language model (LLM) prompt structured to instruct an LLM to create an image, the generating being per first predefined rules and based on results of the analyzing, the identifying, and the calculating; submitting the LLM prompt to a text-to-image model; receiving a visual from the text-to-image model in response to at least the submitting; second generating at least one score, per second predefined rules, for the visual; and returning to the first generating with recommendations to modify the LLM prompt.

The system may have optional features. The visual may be a still image or a video image. The operations may include accepting the visual in response to at least the at least one score satisfying the predetermined scoring criteria. The first predefined rules may define the LLM prompt to include a target audience identification, at least one keyword, a minimum readability score according to predetermined readability criteria, and physical layout directions for content of the image. The at least one score may include: a coherence score that represents a logic flow of content in the visual; a relevance score that represents alignment of the content of the visual with at least one target theme; and a number of keywords identified by the LLM prompt that are absent from the visual. The returning to the first generating with recommendations to modify the LLM prompt may include: third generating first instructions to add any missing keywords; fourth generating second instructions to increase the coherence score; and/or fifth generating third instructions to increase the relevance score. The analyzing the document for metrics may include determining word density of the document, character to word ratio, text to white space ratio, font weight average, font size distribution, and a percentage of the document covered by text. The at least one readability score may include a Flesch Reading Ease score, a Gunning Fog Index, and an average word length of words in the text.

According to an embodiment, a non-transitory computer readable media, storing instructions programmed to cooperate with a processor to cause the processor to perform operations for generating a visual content from a document that includes text is provided. The operations include: analyzing the document for metrics on appearance of the text within the document; identifying a frequency of occurrence of content within the document; calculating at least one readability score of the text within the document; first generating a large language model (LLM) prompt structured to instruct an LLM to create an image, the generating being per first predefined rules and based on results of the analyzing, the identifying, and the calculating; submitting the LLM prompt to a text-to-image model; receiving a visual from the text-to-image model in response to at least the submitting; second generating at least one score, per second predefined rules, for the visual; and returning to the first generating with recommendations to modify the LLM prompt.

The above embodiment may have various optional features. The visual may be a still image or a video image. The operations may include accepting the visual in response to at least the at least one score satisfying the predetermined scoring criteria. The first predefined rules may define the LLM prompt to include a target audience identification, at least one keyword, a minimum readability score according to predetermined readability criteria, and physical layout directions for content of the image. The at least one score may include: a coherence score that represents a logic flow of content in the visual; a relevance score that represents alignment of the content of the visual with at least one target theme; and a number of keywords identified by the LLM prompt that are absent from the visual. The returning to the first generating with recommendations to modify the LLM prompt may include: third generating first instructions to add any missing keywords; fourth generating second instructions to increase the coherence score; and/or fifth generating third instructions to increase the relevance score. The analyzing the document for metrics may include determining word density of the document, character to word ratio, text to white space ratio, font weight average, font size distribution, and a percentage of the document covered by text. The at least one readability score may include a Flesch Reading Ease score, a Gunning Fog Index, and an average word length of words in the text.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for using an AI/ML model in accordance with an embodiment.

FIG. 2 illustrates an exemplary diagram of a network environment with a device for using an AI/ML model in accordance with an embodiment.

FIG. 3 illustrates a system diagram for implementing a method for using an AI/ML model in accordance with an embodiment.

FIG. 4 illustrates an exemplary flow chart of a process for using an AI/ML model to perform conversion of a document including text into a visual in an objective and uniform manner, in accordance with an embodiment.

FIG. 5 illustrates a data flow that corresponds to a process for using an AI/ML model to perform conversion of a document including text into a visual in an objective and uniform manner, in accordance with an embodiment.

FIG. 6 illustrates a data flow that corresponds to a process for using an AI/ML model to perform conversion of a document including text into a visual in an objective and uniform manner, in accordance with an embodiment.

FIG. 7 illustrates a data flow that corresponds to a process for using an AI/ML model to perform conversion of a document including text into a visual in an objective and uniform manner, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

References to any “example” herein (e.g., “for example”, “an example of”, by way of example” or the like) are to be considered non-limiting examples regardless of whether expressly stated or not.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The traditional approaches to creating visuals have multiple technical and uniformity problems. A first technical problem is that creation of visuals is entirely subjective. Give two different content creators the same content, they will generate vastly different result visuals. There is no basis to establish uniform and consistent results between different content creators. This applies not only to the visual itself, but text (written or spoken words) content within the visual. For example, if the target audience for the visual is college educated individuals, then the content creators' perception of that education level is again entirely subjective; one content creator may lean toward visuals more appropriate for college freshman while another content creator may generate visuals that lean toward college seniors.

It is known to use AI text-to-image models to generate images from a text LLM prompt. However, as the LLM prompts are often subjective, the visuals from the model can vary considerably. Often the user is not satisfied with the response, such as the visual being too generic or not what the user was specifically looking for. The initial problem was the user, who typically is not trained in AI prompt formats, is not entering sufficiently targeted prompts to generate a satisfactory response. The user will then typically generate a modified prompt based on the prior response, and then receive a new response. If this new response is not satisfactory, the process can continue indefinitely. A technical problem with this methodology is that each AI prompt submission consumes a great deal of electrical power, such that continual resubmission of modified prompts in search of a satisfactory response consumes that much more power. Simply stated, receiving a satisfactory answer after ten AI prompt submissions consumes far more power than receiving a satisfactory response after one AI prompt submission.

Excessive power consumption is a particular technical problem in the field of AI art generation, in which a user enters a text prompt to describe an image, and the AI generates an image from the description. Since art is subjective, users are rarely satisfied with the initial resulting art, and thus will continually submit modified input prompts to alter the image more to their liking. This continual resubmission of input prompts to arrive at an acceptable end art product consumes a great deal of power.

According to an embodiment, a methodology for generating a visual content from a document that includes text is provided. The methodology includes: analyzing the document for metrics on appearance of the text within the document; identifying a frequency of occurrence of content within the document; calculating at least one readability score of the text within the document; first generating a large language model (LLM) prompt structured to instruct an LLM to create an image, the generating being per first predefined rules and based on results of the analyzing, the identifying, and the calculating; submitting the LLM prompt to a text-to-image model; receiving a visual from the text-to-image model in response to at least the submitting; second generating at least one score, per second predefined rules, for the visual; and returning to the first generating with recommendations to modify the LLM prompt.

The above methodology provides a technical solution to the noted technical problems. The visual generation process is objective in analysis of the starting text document for metrics, frequency and readability scores. The methodology then generates an LLM prompt per specific rules with content from the analysis, which is provided to a text-to-image model to generate a responsive visual which can be scored. The resulting visual is objectively rejected and returned if the scores are not satisfied. Subjective considerations are removed from the process of generating the visual, save for the final approval by the end user.

Since the visual is generated based on an objective methodology rather than a subjective one, the probability of the end user being satisfied with the end product rises considerably, thus reducing the number of AI resubmissions to reach final product. This eliminates the excessive power consumption of typical AI art generation methodologies by reducing the number of AI prompts the user will need to submit to reach an acceptable piece of art. By avoiding extra AI cycles, the methodology avoids the corresponding power expenditure, such that the methodology overall consumes less power than typical AI art generators.

Several definitions that apply throughout this disclosure will now be presented.

The terms “substantial”, “substantially” or the like are defined to be essentially conforming to the particular dimension, shape, or other feature that the term modifies, such that the component need not be exact. For example, “substantially cylindrical” means that the object resembles a cylinder, but can have one or more deviations from a true cylinder. The terms are used as a modifier to imply “approximate” rather than “perfect.” It is a term of approximation, not a term of degree.

The term “comprising” when utilized means “including, but not necessarily limited to”; it specifically indicates open-ended inclusion or membership in the so-described combination, group, series and the like.

The term “a” means “one or more” unless the context clearly indicates a single element.

The term “about” when used in connection with a numerical value means a variation consistent with the range of error in equipment used to measure the values, for which ±5% may be expected.

“First,” “second,” etc., re labels to distinguish components or blocks of otherwise similar names, but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

As used herein, the term “front”, “rear”, “left,” “right,” “top” and “bottom” or other terms of direction, orientation, and/or relative position are used for explanation and convenience to refer to certain features of this disclosure. However, these terms are not absolute, and should not be construed as limiting this disclosure.

Shapes as described herein are not considered absolute. As is known in the art, surfaces often have waves, protrusions, holes, recesses, etc. to provide rigidity, strength and functionality. All recitations of shape (e.g., cylindrical) herein are to be considered modified by “substantially” regardless of whether expressly stated in the disclosure or claims, and specifically accounts for variations in the art as noted above.

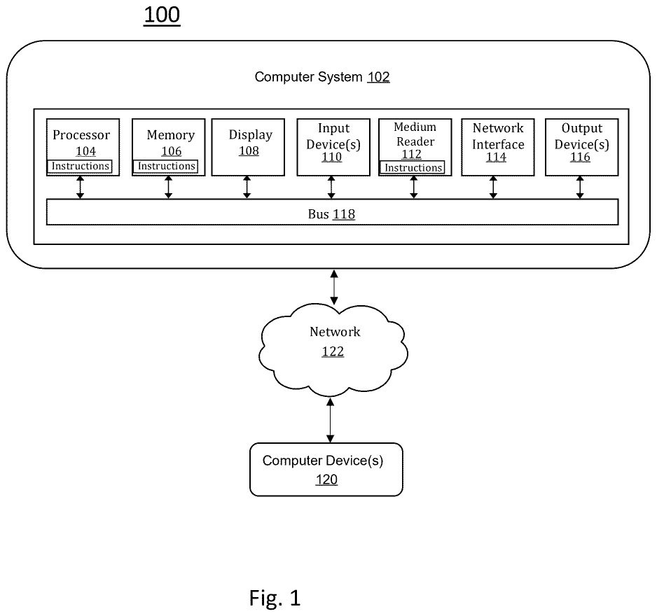

FIG. 1 is an exemplary system 100 for use in implementing a method for using an AI/ML model to perform conversion of a document including text into a visual in an objective and uniform manner, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain′t Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

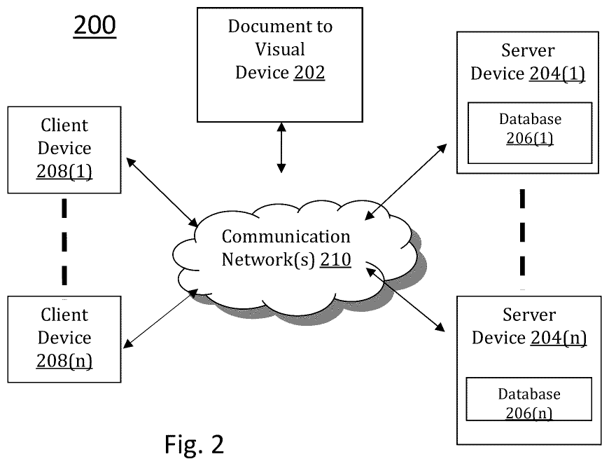

Referring to FIG. 2, a schematic of an exemplary network environment 200 for implementing document to visual device (DTVD) of the instant disclosure is illustrated.

In some embodiments, the above-described problems associated with conventional tools may be overcome by implementing an DTVD 202 as illustrated in FIG. 2 that may be configured for implementing a method for using an AI/ML model to perform conversion of a document including text into a visual in an objective and uniform manner, but the disclosure is not limited thereto.

The DTVD 202 may have one or more computer system 102s, as described with respect to FIG. 1, which in aggregate provide the necessary functions.

The DTVD 202 may store one or more applications that can include executable instructions that, when executed by the DTVD 202, cause the DTVD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DTVD 202 itself, may be located in virtual server(s) running in a cloud-based computing environment rather than being tied to one or more specific physical network computing devices. Also, the application(s) may be running in one or more virtual machines (VMs) executing on the DTVD 202. Additionally, in one or more embodiments of this technology, virtual machine(s) running on the DTVD 202 may be managed or supervised by a hypervisor.

In the network environment 200 of FIG. 2, the DTVD 202 is coupled to a plurality of server devices 204(1)-204(n) that hosts a plurality of databases 206(1)-206(n), and also to a plurality of client devices 208(1)-208(n) via communication network(s) 210. A communication interface of the DTVD 202, such as the network interface 114 of the computer system 102 of FIG. 1, operatively couples and communicates between the DTVD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DTVD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DTVD 202 may be a standalone device or integrated with one or more other devices or apparatuses, such as one or more of the server devices 204(1)-204(n), for example. In one particular example, the DTVD 202 may be hosted by one of the server devices 204(1)-204(n), and other arrangements are also possible. Moreover, one or more of the devices of the DTVD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DTVD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the DTVD 202 that may efficiently provide a platform for implementing a method for using an AI/ML model to perform conversion of a document including text into a visual in an objective and uniform manner, but the disclosure is not limited thereto.

The client devices 208(1)-208(n) may run interface applications, such as standard web browsers or standalone client applications, which may provide an interface to communicate with the DTVD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the DTVD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the DTVD 202, the server devices 204(1)-204(n), or the client devices 208(1)-208(n), for example, may be configured to operate as virtual instances on the same physical machine. For example, one or more of the DTVD 202, the server devices 204(1)-204(n), or the client devices 208(1)-208(n) may operate on the same physical device rather than as separate devices communicating through communication network(s) 210. Additionally, there may be more or fewer DTVDs 202, server devices 204(1)-204(n), or client devices 208(1)-208(n) than illustrated in FIG. 2. In some embodiments, the DTVD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

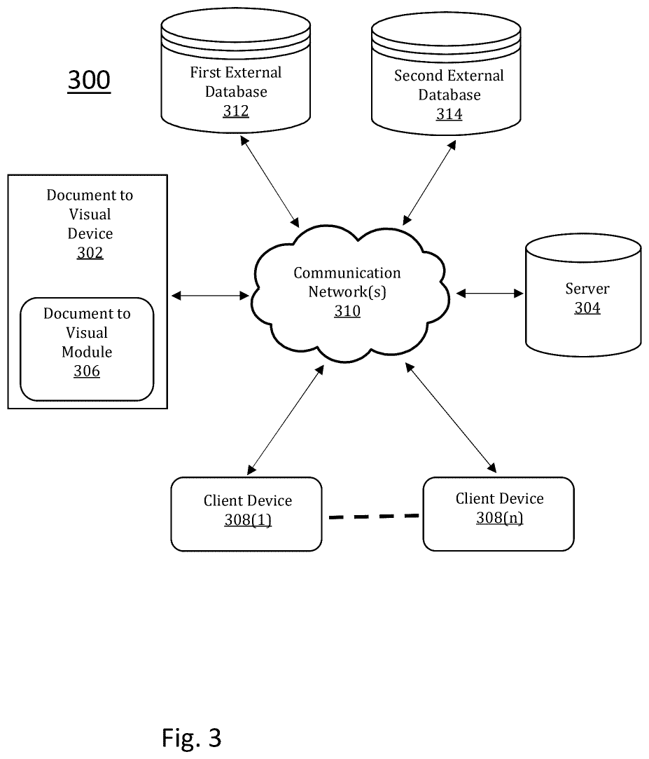

FIG. 3 illustrates a system diagram for implementing an DTVD 302 having an document to video module (DTVM), in accordance with an embodiment.

As illustrated in FIG. 3, the system 300 may include an DTVD 302 within which an DTVM 306 is embedded, a server 304, a first external database 312, a second external database 314, a plurality of client devices 308(1) . . . 308(n), and a communication network 310.

In some embodiments, the DTVD 302 including the DTVM 306 may be connected to the server 304, and the database(s) 312 via the communication network 310. The DTVD 302 may also be connected to the plurality of client devices 308(1) . . . 308(n) via the communication network 310, but the disclosure is not limited thereto.

In an embodiment, the DTVD 302 is described and shown in FIG. 3 as including the DTVM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the DTVM 306 may be configured to receive real-time feed of data from the plurality of client devices 308(1) . . . 308(n) and secondary sources via the communication network 310.

The plurality of client devices 308(1) . . . 308(n) are illustrated as being in communication with the DTVD 302. In this regard, the plurality of client devices 308(1) . . . 308(n) may be “clients” (e.g., customers) of the DTVD 302 and are described herein as such. Nevertheless, it is to be known and understood that the plurality of client devices 308(1) . . . 308(n) need not necessarily be “clients” of the DTVD 302, or any entity described in association therewith herein. Any additional or alternative relationship may exist between either or both of the plurality of client devices 308(1) . . . 308(n) and the DTVD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the DTVD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The DTVD 302 may be the same or similar to the DTVD 202 as described with respect to FIG. 2, including any features or combination of features described with respect thereto.

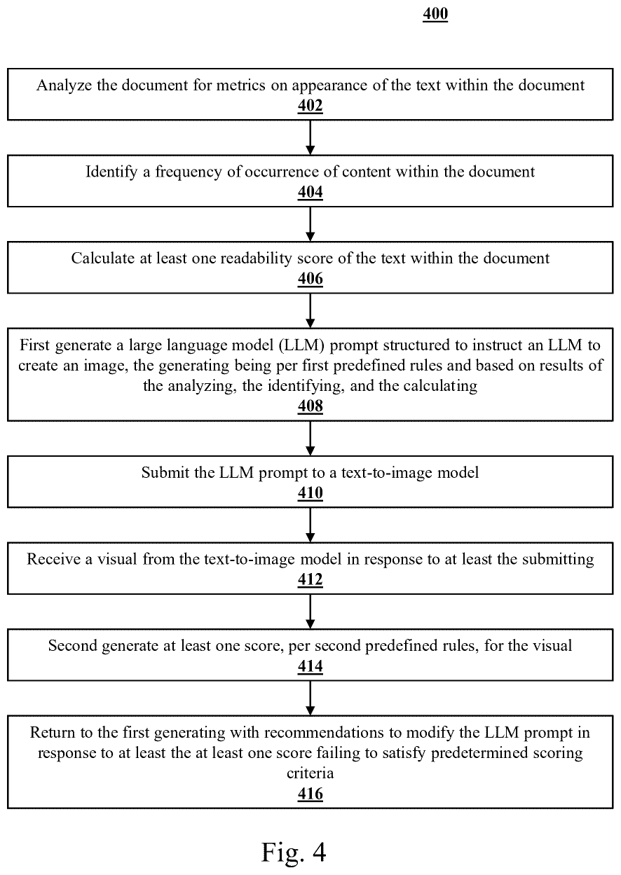

FIG. 4 illustrates an exemplary flow chart of a process 400 implemented by the DTVM 306 of FIG. 3 for enablement of a system and a method for using an AI/ML model to perform conversion of a document including text into a visual in an objective and uniform manner, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include analyzing a document for metrics on appearance of the text within the document.

At step 404, the process may include identifying a frequency of occurrence of content within the document.

At step 406, the process may include calculating at least one readability score of the text within the document.

At step 408, the process may include first generating a large language model (LLM) prompt structured to instruct an LLM to create an image, the first generating being per first predefined rules and based on results of the analyzing, the identifying, and the calculating.

At step 410, the process may include submitting the LLM prompt to a text-to-image model.

At step 412, the process may include receiving a visual from the text-to-image model in response to at least the submitting.

At step 414, the process may include second generating at least one score, per second predefined rules, for the visual.

At step 416, the process may include returning to the first generating with recommendations to modify the LLM prompt in response to at least the at least one score failing to satisfy predetermined scoring criteria.

The above methodology provides a technical solution to the noted technical problems. The visual generation process is objective in analysis of the starting text document for metrics, frequency and readability scores. The methodology then generates an LLM prompt per specific rules with content from the analysis, which is provided to a text-to-image model to generate a responsive visual which can be scored. The resulting visual is objectively rejected and returned if the scores are not satisfied. Subjective considerations are removed from the process of generating the visual, save for the final approval by the end user.

Since the visual is generated based on an objective methodology rather than a subjective one, the probability of the end user being satisfied with the end product rises considerably, thus reducing the number of AI resubmissions to reach final product. This eliminates the excessive power consumption of typical AI art generation methodologies by reducing the number of AI prompts the user will need to submit to reach an acceptable piece of art. By avoiding extra AI cycles, the methodology avoids the corresponding power expenditure, such that the methodology overall consumes less power than typical AI art generators.

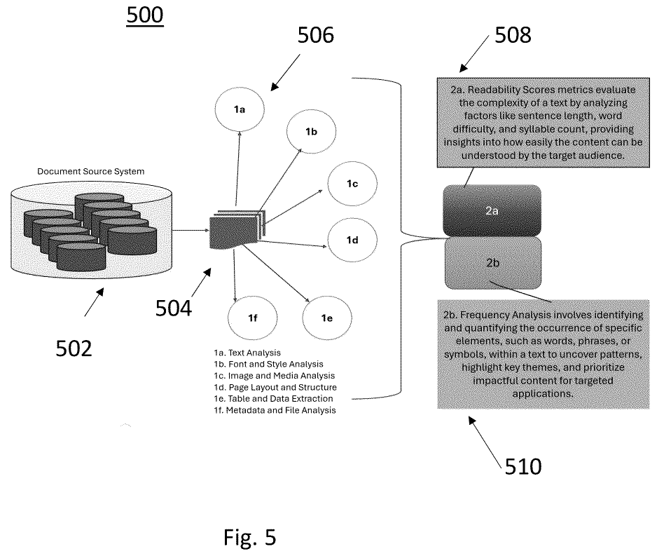

Referring now to FIG. 5, a workflow is shown for converting a document into a visual, and specifically a workflow for analyzing the document for metrics on appearance of the text within the document, identifying a frequency of occurrence of content within the document; and calculating at least one readability score of the text within the document.

A document repository 502 stores documents, for which one or more documents (hereinafter referred to as “document” 504, although it is to be understood that that “a document” refers to one or more documents) is selected for conversion into a visual. The document includes at least some word text, although it may also include non-text content such as images, data, symbols, tables, graphs, etc.

At 506, the document 504 undergoes analysis to determine metrics of appearance of content within the document. Non-limiting examples of the analysis and the corresponding methodology are as follows:

1a. Text Analysis:

### Word Density:

$$Algorithm : Word Density = Total Word Count / Total Page Count$$

Useful for measuring how text-heavy each page is.

### Character-to-Word Ratio:

$$Algorithm : Character - to - Word Ratio = Total Characters / Total Words$$

Indicates the average word length in the document.

### Text-to-Whitespace Ratio:

$$Algorithm : Text - to - Whitespace Ratio = \\ Total Characters ( Excluding Whitespace ) / \\ Total Characters ( Including Whitespace )$$

Useful for evaluating text compactness.

1b. Font and Style Analysis:

### Font Weight Average:

$$Algorithm : Average Font Weight = Sum of Font Weights for All Text Blocks / Number of Text Blocks$$

Provides insights into boldness across the document.

### Font Size Distribution:

Analysis: Plot or compute statistical measures (mean, median, standard deviation) for font sizes across the document.

1c. Image and Media Analysis:

### Image-to-Text Ratio:

$$Algorithm : Image - to - Text Ratio = Total Image Count / Total Page Count$$

Determines the visual-to-text content ratio.

### Average Image Size:

$$Algorithm : Average Image Size = Sum of Image Sizes ( Height \times Width ) / Number of Images$$

Highlights the resolution consistency across embedded images.

1d. Page Layout and Structure:

### Text Coverage:

$$Algorithm : Text Coverage Percentage = Text Area ( Height \times Width of Text Blocks ) / \\ Total Page Area ( Height \times Width of Page ) \times 100$$

Measures the proportion of the page covered by text.

### Header/Footer Repetition:

Analysis: Check for duplicate header/footer content across pages using similarity scoring (e.g., cosine similarity).

1e. Table and Data Extraction:

### Table-to-Page Ratio:

$$Algorithm : Table - to - Page Ratio = Total Number of Tables / Total Page Count$$

Identifies how data-intensive the document is.

1f. Metadata and File Analysis:

### File Weight per Page:

$$Algorithm : File Weight per Page = Total File Size ( MB ) / Total Page Count$$

Helps assess file efficiency and resource usage.

Compression Ratio (if original size is known):

$$Algorithm : Compression Ratio = Original File Size / Compressed File Size$$

Useful for evaluating optimization levels.

A non-limiting example of the results of such an analysis are as follows:

```
text_analysis = {
  “total_words”: 1200,
  “total_characters”: 6000,
  “unique_words”: 350,
  “high_frequency_words”: {“Learn”: 45, “Future”: 30, “Success”: 20}
}
font_style_analysis = {
  “bold_text_count”: 50,
  “italic_text_count”: 30,
  “font_size_average”: 12,
  “unique_fonts”: 3
}
image_media_analysis = {
  “total_images”: 10,
  “image_to_text_ratio”: 0.2 # proportion of images relative to text
}
page_layout_structure = {
  “total_pages”: 5,
  “text_coverage_percentage”: 75, # text coverage of page
  “average_whitespace_percentage”: 25
}
table_data_extraction = {
  “total_tables”: 3,
  “data_points_extracted”: 15
}
metadata_analysis = {
  “keywords”: [“Education”, “Career”, “Global”],
  “author”: “Marketing Team”,
  “creation_date”: “2023-10-01”
```

At 508, readability score metrics are evaluated. Non-limiting examples of the readability score metrics include the Flesch Reading Ease score, the Gunning Fox Index, and/or the average word length.

A non-limiting example of an algorithm to determine the readability metrics is as follows:

a. Flesch Reading Ease Score

```
  flesch_reading_ease = 206.835 − (1.015 *
(text_analysis[“total_words”] / text_analysis[“total_sentences”])) − (
    84.6 * (text_analysis[“total_syllables”] /
    text_analysis[“total_words”]))
  b. Gunning Fog Index
  gunning_fog_index = 0.4 * (
    (text_analysis[“total_words”] / text_analysis[“total_sentences”]) +
    (text_analysis[“complex_words”] / text_analysis[“total_words”]) *
    100)
  c.Average Word Length (as a complementary readability measure)
  average_word_length = text_analysis[“total_characters”] /
text_analysis[“total_words”]
```

These metrics can be combined as follows into summary:

```
readability_metrics = {
  “Flesch Reading Ease”: flesch_reading_ease,
  “Gunning Fog Index”: gunning_fog_index,
  “Average Word Length”: average_word_length
}
```

For the analysis example above, the readability score analysis yields the following frequency analysis metrics:

```
    {
  “Flesch_Reading_Ease”: 55.575,
  “Gunning_Fog_Index”: 14.6,
  “Average_Word_Length”: 5.0,
  “Insights”: “Evaluates text complexity by analyzing sentence length,
word difficulty, and syllable count.”
```

At 510, the results of the analysis undergo frequency analysis to identify and quantify the occurrence of specific elements, such as words, phrases, or symbols, within the text to uncover patterns, highlight key themes, and prioritize impactful content for targeted applications.

Below is a non-limiting example of a frequency analysis algorithm:

```
  frequency_analysis_metric = {
    “word_density”: text_analysis[“total_words”] /
page_layout_structure[“total_pages”],
    “character_to_word_ratio”: text_analysis[“total_characters”] /
text_analysis[“total_words”],
    “text_to_image_ratio”: text_analysis[“total_words”] /
image_media_analysis[“total_images”],
    “text_coverage_normalized”:
page_layout_structure[“text_coverage_percentage”] / 100,
    “font_variety_score”: font_style_analysis[“unique_fonts”] *
font_style_analysis[“font_size_average”],
    “keyword_frequency”:
sum(text_analysis[“high_frequency_words”].values( )),
```

For the analysis example above, the frequency analysis yields the following frequency analysis metrics:

```
      {
    “Word_Density”: 240.0,
    “Character_to_Word_Ratio”: 5.0,
    “Text_to_Image_Ratio”: 120.0,
    “Text_Coverage_Normalized”: 0.75,
    “Font_Variety_Score”: 36,
    “Keyword_Frequency”: 95,
    “Insights”: “Identifies and quantifies elements like words, phrases,
and symbols to uncover patterns and prioritize impactful content.”
  }
```

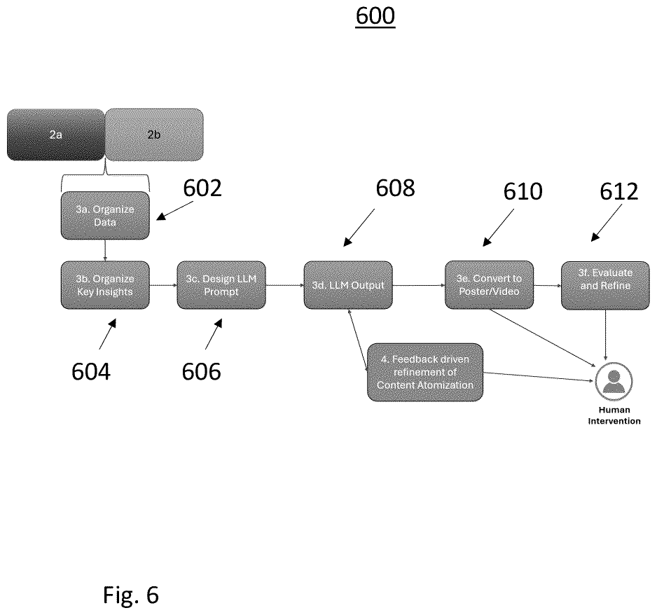

Referring now to FIG. 6, the workflow continues to the generation of a visual from the foregoing analysis, and particularly generating a large language model (LLM) prompt structured to instruct an LLM to create an image, the generating being per first predefined rules and based on results of the analyzing, the identifying, and the calculating, submitting the LLM prompt to a text-to-image model, and receiving a visual from the text-to-image model in response to at least the submitting.

At 602 and 604, the methodology uses a properly trained AI/ML model to read a Json dataset from the prior analysis and extract relevant insights to guide the visual creation. Non-limiting examples of key insights include:

### Frequency Analysis Insights:

High-frequency words: Identify words that appear with high frequency, relative to predefined criteria (e.g., five or more times in the document), and use these high frequency words as keywords or taglines in the visual.

Word density and font variety: Inform text hierarchy and font size distribution.

Text-to-image ratio: Ensure a balance between text and visuals.

### Readability Scores Insights:

Flesch Reading Ease: Adjust sentence complexity and word choice for the target audience.

Average word length: Use simpler, shorter words for easier readability if necessary.

Gunning Fog Index: Ensure the poster's language aligns with the desired sophistication level.

Document Text Data: Extract key messages, slogans, or phrases; identify text sections with emotional appeal or call-to-action elements.

At 606, the AI/ML will generate an LLM prompt from the foregoing. This step uses the insights to craft a detailed prompt for the LLM. The prompt should guide the model to: generate the textual content for the image; include style and formatting instructions based on the metrics; and use the key extracted keywords.

A non-limiting example of a prompt is as follows:

Create a text poster advertisement using the following data:
**Target Audience**: Professionals and business owners.
**Main Content**
   Keywords: “Real Estate Loans,” “Low Interest Rates,” “Flexible Terms,” “Custom Plans.”
   Insights: Emphasize readability (Flesch Reading Ease>50) and professional tone.
   Call-to-Action: “Apply Today!” or “Contact Us for More Information.”
**Visual Structure**
   Header: Bold, attention-grabbing with a strong message.
   Body: Concise, readable text (average word length ~5 characters).
   Footer: Call-to-action with relevant contact info.
**Data Context**
   Text-to-image ratio: Ensure a balance of visuals and whitespace.
   Font variety: Use distinct styles to emphasize key points.
Include these phrases or concepts: “Empowering Your Business Growth with Real Estate Solutions,” “Fast Approval Process.”.

At 608, the physical parameters of the visual to be created are provided by the AI/ML. A non-limiting example of code for the same is:

```
  from PIL import Image, ImageDraw, ImageFont
  # Function to generate a commercial real estate advertisement poster
  def create_real_estate_poster(output_path):
    # Poster dimensions
    width, height = 800, 1000
    background_color = “white”
    text_color = “black”
    header_font_size = 50
    body_font_size = 30
    footer_font_size = 40
    # Create a blank image
    img = Image.new(‘RGB’, (width, height), color=background_color)
    draw = ImageDraw.Draw(img)
    # Load fonts
    try:
      header_font = ImageFont.truetype(“arial.ttf”, header_font_size)
      body_font = ImageFont.truetype(“arial.ttf”, body_font_size)
      footer_font = ImageFont.truetype(“arial.ttf”, footer_font_size)
    except IOError:
      # Default font if specified font is not available
      header_font = ImageFont.load_default( )
      body_font = ImageFont.load_default( )
      footer_font = ImageFont.load_default( )
    # Add content
    header_text = “Empowering Your Business Growth with Real Estate
Solutions”
    body_text = (
      “Flexible real estate loans with low-interest rates and customizable plans.
”
      “Enjoy fast approval processes tailored to meet your business needs.”
    )
    footer_text = “Apply Today! Call 123-456-7890 or Visit www.realestate-
loans.com”
    # Header
    draw.multiline_text(
      (50, 50),
      header_text,
      fill=text_color,
      font=header_font,
      align=“center”
    )
    # Body
    draw.multiline_text(
      (50, 200),
      body_text,
      fill=text_color,
      font=body_font,
      align=“left”,
      spacing=10
    )
    # Footer (Call-to-Action)
    draw.multiline_text(
      (50, 800),
      footer_text,
      fill=“blue”,
      font=footer_font,
      align=“center”
    )
    # Save the poster
    img.save(output_path)
    print(f“Poster saved at {output_path}”)
```

At 610, the LLM content generated at 606 and 608 as organized per the predefined rules is provided to a text-to-image model, which provides a visual in response thereto. The predefined rules define the content and layout of the visual per steps 606 and 608 that the visual must conform to.

In the foregoing example the requested content was a poster, and a poster would be provided. In another example, a video is requested, and a corresponding video is provided. Multiple visuals, including combination of still and moving visuals, may be provided if so requested in the LLM prompt.

At 612, the resulting visual will be validated relative to metrics, and user feedback may be gathered.

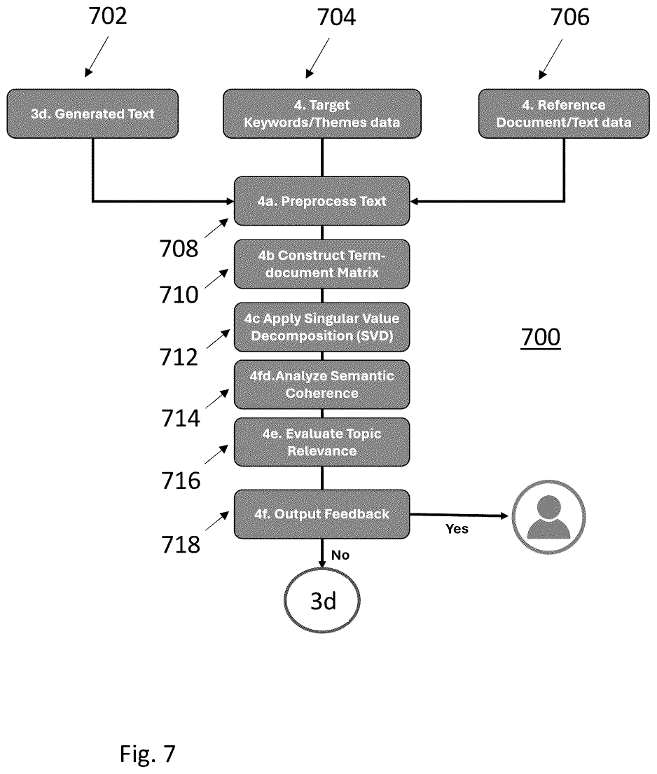

Referring now to FIG. 7, a workflow 700 shows a methodology performed by the AI/ML to objectively validate the visual.

The workflow may have three inputs. The first input at 702 is the generated LLM generated content from 608 in FIG. 6. The second input 704 is any target keywords or themes as previously identified from FIGS. 5 and 6, which identifies any expected terms or semantic phrases to appear in the visual. The third input 706 may be the reference document 504 itself, which can be used for topic alignment analysis.

At 708, the AI/ML preprocess the text by normalizing and cleaning the data. This prepares the input text for semantic analysis.

A non-limiting example of the preprocessing methodology is as follows:

Tokenize the text into sentences and words.

Remove stop words, punctuation, and irrelevant characters.

Convert all text to lowercase for uniformity.

Apply stemming or lemmatization to reduce words to their root forms.

Split the content into atomic units:

Break paragraphs into smaller, meaningful sentences or phrases (atoms).

At 710, the next step is for the AI/ML to construct a term-document matrix. The objective is to represent the relationships between terms and textual units (sentences, phrases, or documents).

A non-limiting example of the constructing such a matrix is as follows:

Create a matrix where:

$$Rows = Terms ( keywords or vocabulary ) .$$

$$Columns = Atomic units ( sentences or phrases ) .$$

Populate the matrix using TF-IDF:

Term Frequency (TF): Frequency of a term in an atomic unit.

Inverse Document Frequency (IDF): Measures the term's uniqueness across all units.

The invention is not limited to the specific columns and rows, and other organizational structures could be used.

At 712, a Singular Value Decomposition (SVD) is applied with the intent to extract latent semantic relationships between terms and atomic units.

A non-limiting example of the SVD is as follows: Decompose the term-document matrix into three matrices

$$A = U \cdot \sum \cdot VT$$

Where:
U: Matrix capturing term-concept relationships.
Σ: Diagonal matrix of singular values (importance of concepts).
VT: Matrix capturing concept-document relationships.

Retain only the top k singular values (dominant concepts), where k is a predetermined number.

At 714, a Semantic Coherence analysis is performed, with the object of evaluating how well atomic units align with latent semantic concepts.

A non-limiting example of the above analysis is as follows:

Compute pairwise cosine similarity between consecutive atomic units using their vectors from VT.

Aggregate the similarities to compute a semantic coherence score.

$$Coherence Score = \sum i = 1 n - 1 Cosine Similarity ( vi , vi + 1 ) / n - 1$$

Where vi is the vector for the i-th atomic unit.

At 716, the AI/ML evaluates topical relevance to assess how well the generated text aligns with target themes or reference material.

A non-limiting example of the evaluation is as follows:

Compute the cosine similarity between:
The semantic vectors of the generated text (VT).
Semantic vectors of target keywords or reference documents.

Aggregate the similarity scores to compute a relevance score.

$$Relevance Score = \sum i = 1 k Cosine Similarity ( vi , ki ) / k$$

Where ki is the vector for the i-th keyword.

At 718, the AI/ML will determine the coherence score and relevance score of the visual relative to predetermined criteria and identify any missing keywords. If the scores satisfy predetermined criteria, the visual objectively passes and is submitted to the observer for their review.

If either of the scores fail to meet the predetermined criteria, or if there are missing keywords, then the subroutine generates recommendations on how to improve the score(s) and add any missing keywords, and control returns to 608 for incorporation into a new LLM submission.

Below is a non-limiting example of pseudocode for the functionality of the operations in FIG. 7:

```
import numpy as np
from sklearn.feature_extraction.text import TfidfVectorizer
from sklearn.decomposition import TruncatedSVD
from sklearn.metrics.pairwise import cosine_similarity
def lsa_feedback_algorithm(text, keywords, reference=None):
  # Step 1: Preprocess Text
  atomic_units = preprocess_text(text) # Tokenize, clean, and atomize content
  # Step 2: Construct Term-Document Matrix
  vectorizer = TfidfVectorizer(stop_words=‘english’)
  term matrix = vectorizer.fit_transform(atomic_units)
  # Step 3: Apply Singular Value Decomposition (SVD)
  svd = TruncatedSVD(n_components=2)
  svd matrix = svd.fit transform(term_matrix)
  # Step 4: Analyze Semantic Coherence
  coherence_scores = [
    cosine_similarity([svd_matrix[i], [svd_matrix[i+1]])[0, 0]
    for i in range(len(svd_matrix) − 1)
  ]
  coherence_score = np.mean(coherence_scores)
  # Step 5: Evaluate Topic Relevance
  keyword matrix = vectorizer.transform([‘ ’.join(keywords)])
  relevance scores = cosine_similarity(svd_matrix,
keyword_matrix).flatten( )
  relevance_score = np.mean(relevance_scores)
  # Step 6: Output Feedback
  missing_keywords = set(keywords) −
set(vectorizer.get_feature_names_out( ))
  return {
    “Coherence Score”: coherence_score,
    “Relevance_Score”: relevance_score,
    “Missing_Keywords”: missing_keywords
  }
def preprocess_text(text):
  # Example preprocessing: Tokenization, lowercase, stopword removal
  sentences = text.split(‘.’)
  return [sentence.strip( ).lower( ) for sentence in sentences if sentence.strip( )]
```

Below is a non-limiting example of inputs to 702, 704, and 706:

```
  {
    “Generated_Text”: “Flexible real estate loans are designed to meet your
needs. Low-interest rates and fast approvals make it easy to grow your business. Customize
your repayment plans today.”,
    “Target_Keywords”: [
      “real estate”,
      “loans”,
      “low-interest rates”,
      “fast approvals”,
      “custom repayment”
    ],
    “Reference_Document”: “Real estate loans offer various benefits such as
low-interest rates, customizable repayment plans, and quick approval processes. These loans
are tailored to help businesses grow efficiently.”
  }
  Below is a non-limiting example of a favorable result at 718 based on a
coherence store threshold of 0.85 and a relevance scope threshold of 0.8:
  {
    “Feedback_Status”: “Yes”,
    “Coherence_Score”: 0.91,
    “Relevance_Score”: 0.85,
    “Missing_Keywords”: [ ],
    “Feedback”: {
      “Strengths”: [
        “Content aligns well with the target keywords and themes.”,
        “Logical flow between sentences is strong.”,
        “All target keywords are included in the content.”
      ],
      “Reccomendations”: [
        “Maintain the current style and logical structure for similar content.”,
        “No refinements required.”
      ]
    }
  }
```

The visual passes objective inspection since the coherence score of 0.91 is above the threshold of 0.85, the relevance Score: 0.85 is above 0.8, and there are no missing keywords.

Below is a non-limiting example of an unfavorable result at 718 based on a coherence store threshold of 0.85 and a relevance scope threshold of 0.8:

```
  {
    “Feedback_Status”: “No”,
    “Coherence_Score”: 0.62,
    “Relevance_Score”: 0.57,
    “Missing_Keywords”: [
      “low-interest rates”,
      “fast approvals”,
      “custom repayment”
    ],
    “Feedback”: {
      “Strengths”: [
        “Content briefly introduces real estate loans.”,
        “Mentions the concept of business growth.”
      ],
      “Recommendations”: [
        “Improve logical flow between sentences to enhance
        coherence.”,
        “Add missing keywords: ‘low-interest rates,’ ‘fast approvals,’
and ‘custom repayment.’”,
        “Expand on benefits like customizable repayment plans to
improve alignment with target themes.”
      ] } }
```

The visual did not pass objective inspection because the coherence score of 0.62 was below the threshold of 0.85 indicating weak logical flow, the relevance score of 0.57 was below the threshold of 0.8 indicating poor alignment with target themes, and keywords “low-interest rates,” “fast approvals,” and “location” are missing from the visual.

In the above examples success/failure was defined by full compliance with the criteria v. full non-compliance. However, the invention is not so limited, and rules may be established that mix and match criteria, e.g., a high coherence score may offset a lower relevance score. The scores may also be weighted as desired. The invention is not limited to any specific criteria for defining success or failure.

The above methodology thus provides for refining content atomization, designed to enhance the creation, analysis, and evaluation of textual and visual media. The process segments content into atomic units (e.g., sentences or phrases), facilitating precise semantic analysis and iterative refinement. Techniques such as Term-Document Matrix construction, TF-IDF analysis, and Singular Value Decomposition (SVD) are used to identify latent semantic relationships between terms and content units. The system evaluates semantic coherence and topic relevance using metrics like cosine similarity, coherence scores, and relevance scores, ensuring the content aligns with target themes. Additionally, the system automates the generation of poster images and infographic videos by integrating refined content with customizable visual templates. It applies design principles such as text-to-image ratio, font variety, and visual hierarchy to ensure the visual output is professional and impactful. Feedback mechanisms, both automatic and manual, refine textual and visual content, optimizing it for readability, audience engagement, and relevance.

In some embodiments as disclosed above in FIGS. 1-7, technical improvements effected by the instant disclosure may include a platform for implementing a conversion of a document including text into a visual in an objective and uniform manner, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method for generating a visual content from a document that includes text, the method comprising:
analyzing the document for metrics on visual appearance of the text within the document, the metrics including word density of the document, character to word ratio, text to white space ratio, font weight average, font size distribution, and a percentage of the document covered by text;
identifying a frequency of occurrence of content within the document;
calculating at least one readability score of the text within the document;
first generating a large language model (LLM) prompt structured to instruct an LLM to create an image, the first generating being per first predefined rules and based on results of the analyzing, the identifying, and the calculating;
submitting the LLM prompt to a text-to-image model;
receiving a visual from the text-to-image model in response to at least the submitting;
second generating at least one score, per second predefined rules, for the visual; and
returning to the first generating with recommendations to modify the LLM prompt in response to at least the at least one score failing to satisfy predetermined scoring criteria.

2. The method of claim 1, wherein the visual is a still image or a video image.

3. The method of claim 1, further comprising:
accepting the visual in response to at least the at least one score satisfying the predetermined scoring criteria.

4. The method of claim 1, wherein the first predefined rules define the LLM prompt to include a target audience identification, at least one keyword, a minimum readability score according to predetermined readability criteria, and physical layout directions for content of the image.

5. The method of claim 1, wherein the at least one score comprises:
a coherence score that represents a logic flow of content in the visual;
a relevance score that represents alignment of the content of the visual with at least one target theme; and
a number of keywords identified by the LLM prompt that are absent from the visual.

6. The method of claim 5, wherein the returning to the first generating with recommendations to modify the LLM prompt further comprises:
third generating first instructions to add any missing keywords;
fourth generating second instructions to increase the coherence score; and/or
fifth generating third instructions to increase the relevance score.

7. (canceled)

8. The method of claim 1, wherein the at least one readability score includes a Flesch Reading Ease score, a Gunning Fog Index, and an average word length of words in the text.

9. A system for generating a visual content from a document that includes text, the system comprising:
a processor;
a memory storing instructions programmed to cooperate with the processor to cause the system to perform operations comprising:
analyzing the document for metrics on visual appearance of the text within the document, the metrics including word density of the document, character to word ratio, text to white space ratio, font weight average, font size distribution, and a percentage of the document covered by text;
identifying a frequency of occurrence of content within the document;
calculating at least one readability score of the text within the document;
first generating a large language model (LLM) prompt structured to instruct an LLM to create an image, the first generating being per first predefined rules and based on results of the analyzing, the identifying, and the calculating;
submitting the LLM prompt to a text-to-image model;
receiving a visual from the text-to-image model in response to at least the submitting;
second generating at least one score, per second predefined rules, for the visual; and
returning to the first generating with recommendations to modify the LLM prompt in response to at least the at least one score failing to satisfy predetermined scoring criteria.

10. The system of claim 9, wherein the visual is a still image or a video image.

11. The system of claim 9, the operations further comprising:
accepting the visual in response to at least the at least one score satisfying the predetermined scoring criteria.

12. The system of claim 9, wherein the first predefined rules define the LLM prompt to include a target audience identification, at least one keyword, a minimum readability score according to predetermined readability criteria, and physical layout directions for content of the image.

13. The system of claim 9, wherein the at least one score comprises:
a coherence score that represents a logic flow of content in the visual;
a relevance score that represents alignment of the content of the visual with at least one target theme; and
a number of keywords identified by the LLM prompt that are absent from the visual.

14. The system of claim 13, wherein the returning to the first generating with recommendations to modify the LLM prompt further comprises:
third generating first instructions to add any missing keywords;
fourth generating second instructions to increase the coherence score; and/or
fifth generating third instructions to increase the relevance score.

15. (canceled)

16. The system of claim 9, wherein the at least one readability score includes a Flesch Reading Ease score, a Gunning Fog Index, and an average word length of words in the text.

17. A non-transitory computer readable media, storing instructions programmed to cooperate with a processor to cause the processor to perform operations for generating a visual content from a document that includes text, the operations comprising:
analyzing the document for metrics on visual appearance of the text within the document, the metrics including word density of the document, character to word ratio, text to white space ratio, font weight average, font size distribution, and a percentage of the document covered by text;
identifying a frequency of occurrence of content within the document;
calculating at least one readability score of the text within the document;
first generating a large language model (LLM) prompt structured to instruct an LLM to create an image, the first generating being per first predefined rules and based on results of the analyzing, the identifying, and the calculating;
submitting the LLM prompt to a text-to-image model;
receiving a visual from the text-to-image model in response to at least the submitting;
second generating at least one score, per second predefined rules, for the visual; and
returning to the first generating with recommendations to modify the LLM prompt in response to at least the at least one score failing to satisfy predetermined scoring criteria.

18. The non-transitory computer readable media of claim 17, wherein the visual is a still image or a video image.

19. The non-transitory computer readable media of claim 17, the operations further comprising:
accepting the visual in response to at least the at least one score satisfying the predetermined scoring criteria.

20. The non-transitory computer readable media of claim 17, wherein the first predefined rules define the LLM prompt to include a target audience identification, at least one keyword, a minimum readability score according to predetermined readability criteria, and physical layout directions for content of the image.
